(19) United States
(12) Patent Application Publication
(10) Pub. No.: US 2012/0072886 A1
(43) Pub. Date: Mar. 22, 2012

(54) DOMAIN SPECIFIC LANGUAGE CREATION

(75) Inventors: Francis G. McCabe, Cupertino, CA (US); Kenneth R. MacKenzie, Boulder Creek, CA (US)

(73) Assignee: STARVIEW TECHNOLOGY, INC., San Jose, CA (US)

(21) Appl. No.: 12/883,448

(22) Filed: Sep. 16, 2010

(51) Int. Cl. G06F 9/45; G06F 9/44

(52) U.S. Cl. 717/114; 717/140

(57) ABSTRACT

In one embodiment of the present invention, a method for using a domain specific computer language to extend an existing computer language is provided, comprising: creating a rule for validation for a compiler, the rule for validation created in a rule description language created specifically to describe rules for validation, the rule defining a part of the domain specific computer language; examine source text to identify a domain specific language to use for compiling; and compiling the source text using a compiler for an existing computer language using the identified domain specific language, wherein the compiler contains a rules interpretation engine that runs the rules for validation for the identified domain specific language, wherein the rules for validation are external to the compiler.

### BACKGROUND OF THE INVENTION

1. Field of the Invention

The present invention relates to the field of computer software. More particularly, the present invention relates to the creation of a domain specific language.

2. Description of the Related Art

A compiler is a computer program that reads a software program in a first language (also called the source language) and translates it into an equivalent program in a second language (also called the target language). Usually, the target language is closer to machine language that the source language, hence the compiler acts to create a version of the software program that is executable at a level closer to the machine level, speeding execution as little or no runtime translation would be required. Example target languages include assembly language or machine code.

Compilers are generally broken up into a front end and a back end. The front end typically includes analysis phases and an intermediate code generator. The back end typically includes code optimization and final code generation.

The front end can be divided into a number of phases, although not all phases are present in all compilers. Examples of the phases include line reconstruction, lexical analysis, preprocessing, syntax analysis, and semantic analysis. In line reconstruction, an input character sequence is converted to a canonical form. In lexical analysis, the source code text is broken into smaller pieces called tokens. Each token is a single atomic unit of the language. In preprocessing, the lexical tokens are manipulated to allow for macro substitution and conditional compilation. In syntax analysis, the sequence of tokens is parsed to identify the syntactic structure of the program. This phase often involves the building of a parse tree, which replaces the linear sequence of tokens with a tree structure built according to a set of rules. These rules correspond to a formal grammar which defines the language's syntax. In semantic analysis, the computer adds semantic information to the parse tree and builds a symbol table. In this phase, semantic checks can be performed, such as type checking, object binding, or definite assignment.

The back end can also be divided into a number of phases, not all of which may be present in all compilers. Examples of the phases include analysis, optimization, and code generation. In analysis, program information is gathered from the intermediate representation. In optimization, the intermediate language representation is transformed into functionally equivalent, but faster (or smaller), forms. In code generation, the transformed intermediate language is translated into the output language.

As described above, in the front end, a compiler must figure out whether a particular line of code is syntactically correct. This includes performing type checking. Each identifier in the line has a type associated with it. A series of rules hardcoded into the grammar indicates whether or not the type is correct. For example, a common type checking rule might identify which types are permitted to be operated on by an addition (“+”) operation. Obviously two integers can be added together, so a rule would identify that such a combination is permitted. An integer and a string, however, may represent a combination that cannot be added, and a rule would identify it as forbidden. An integer and a floating point can possibly be added, so it may be up to the discretion of the language designer as to whether such a type combination would be permitted for the addition operation.

Of course, this is merely a simple example of a type checking rule. In actuality, the rules may be a lot more complex, even building upon one another using dependencies. Nevertheless, the type checking rules are created by the author of the compiler and hardcoded into the compiler. This makes it difficult to change the rules after the compiler is built.

### SUMMARY OF THE INVENTION

In one embodiment of the present invention, a method for using a domain specific computer language to extend an existing computer language is provided, comprising: creating a rule for validation for a compiler, the rule for validation created in a rule description language created specifically to describe rules for validation, the rule defining a part of the domain specific computer language; examine source text to identify a domain specific language to use for compiling; and compiling the source text using a compiler for an existing computer language using the identified domain specific language, wherein the compiler contains a rules interpretation engine that runs the rules for validation for the identified domain specific language, wherein the rules for validation are external to the compiler.

In a second embodiment of the present invention, a method for creating a domain specific language for a business is provided, the method comprising: identifying objects for the domain specific language, wherein the objects correlate to tangible aspects of the business; identifying operators for the domain specific language, wherein the operators describe actions that can be performed on or between the identified objects; identifying rules for the domain specific language, wherein the rules describe constraints on the objects and operators that correlate to tangible limitations in the business; and incorporating the objects, operators, and rules into a domain specific language external from a compiler but compatible with a rule interpretation engine inside the compiler.

In a third embodiment of the present invention, an apparatus is provided comprising: a tool for authoring rules for validation, in a rule description language created for authoring rules for validation, of a domain specific language; a tool for authoring rules for type checking, in a rule description language created for authoring rules for type checking, of the domain specific language; and a tool for authoring rules for formatting, in a rule description language created for authoring rules for formatting, of the domain specific language.

In a fourth embodiment of the present invention, a program storage device readable by a machine and tangibly embodying a program of instructions executable by the machine to perform a method for using a domain specific computer language to extend an existing computer language is provided, the method comprising: creating a rule for validation for a compiler, the rule for validation created in a rule description language created specifically to describe rules for validation, the rule defining a part of the domain specific computer language; examine source text to identify a domain specific language to use for compiling; and compiling the source text using a compiler for an existing computer language using the identified domain specific language, wherein the compiler contains a rules interpretation engine that runs the rules for validation for the identified domain specific language, wherein the rules for validation are external to the compiler.

### BRIEF DESCRIPTION OF THE DRAWINGS

FIG. 1 is a flow diagram illustrating a method for designing a domain specific language.

FIG. 2 is a flow diagram illustrating a method for using a domain specific computer language to extend an existing computer language in accordance with an embodiment of the present invention.

FIG. 3 is a flow diagram illustrating an alternative method in accordance with an embodiment of the present invention.

FIG. 4 is a flow diagram illustrating a method for incorporating objects, operators, and rules into rules for execution in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In an embodiment of the present invention, rather than hardcode type checking rules into a compiler, an explicit rule language is provided to guide the compilation of a source language. This allows for not only the monitoring of type limitations but also provides for source transformations in an extensible and easily modified manner.

One of the major problems addressed by the present invention is the cognitive gap between how a user thinks about a language and the language syntax itself. Therefore, when a programmer wishes to write a computer program in a computer language, the user must familiarize him or herself with the precise allowable syntax of the language. While a compiler could, in theory, define a language simply enough for a user to understand it easily, there really is no way for the author of the compiler to be able to predict the various potential uses for the language. As such, one of the benefits of the present invention is that it allows a single compiler to be created that can be used by unsophisticated programmers across a wide variety of industries. For example, the present invention would allow for the compiler to essentially be “customized” for use in a semiconductor manufacturing industry and then customized for use in candy manufacturing, without needing to author a new compiler. Thus, the present invention allows a domain specific language to be designed and implemented, without alteration of the compiler itself.

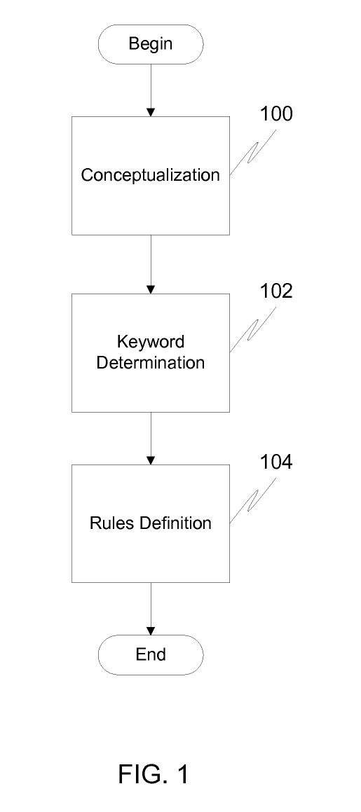

FIG. 1 is a flow diagram illustrating a method for designing a domain specific language. Step 100 is the conceptualization step. In this step, the user asks him or herself a series of questions. These questions include “what are the objects?” “what are the operators?” and “what are the rules?”

As an example, if the user is a patent attorney he may wish to set up a language specifically for performing patent-related tasks (e.g., preparing and filing patent applications, conducting prior art searches, etc.). The answer to “what are the objects?” in this case may be “patent applications,” “claims,” “prior art documents,” “declarations,” “assignments,” etc. The answer to what are the operators in this case may be “combine,” “search,” “file,” “delete,” “monitor,” etc. The answer to “what are the rules” may be a list of rules on which actions are permitted on which objects (e.g., “file” can be used on all objects whereas “monitor” in only permitted on patent applications).

Step 102 is the keyword determination step. In this step, a user can define the names of the various objects, as well as start designing how the keywords can be combined with the various operators.

Step 104 is the rules definition step. Here, various rules are electronically defined based on the keywords. This includes rules for grammar, rules for validation, rules for type checking, rules for formatting, and rules for operational semantics (code generation). In an embodiment of the present invention, a rule description language is generated for each of the rules for validation, the rules for type checking and/or the rules for formatting. This is accomplished by providing a rule-based program text processing environment (rule-based compiler) to allow the user to specify the various rules based on the determinations made in steps 100 and 102.

By operating these tools during the compilation of the program text, the newly created rule is able to provide real-time translation and verification of subsequently encountered program text written according to the newly defined rules even though the new program text would be unrecognizable to the original host language of the compiler.

The present invention extends an existing computer language by allowing a user to define one or more domain specific computer languages that may be used independently of one another in compiling source text. In prior art compilers are essentially “baked into” the compiler, restricting modification of the rules to only compiler-level programmers. The present invention recognizes that computer languages are much like ordinary languages—just like the meaning of English words can vary depending upon local dialect or area of technology, so can a computer language have various sub-languages that may or may not contain overlapping elements. The present invention allows for a user to easily create such sub-languages and use them to compile appropriate source text.

It should be noted that while these domain specific languages can be thought of as sub-languages of the larger existing language, there is no requirement that they in any way overlap or extend the larger existing language. Embodiments are possible where the domain specific language actually replaces the larger existing language.

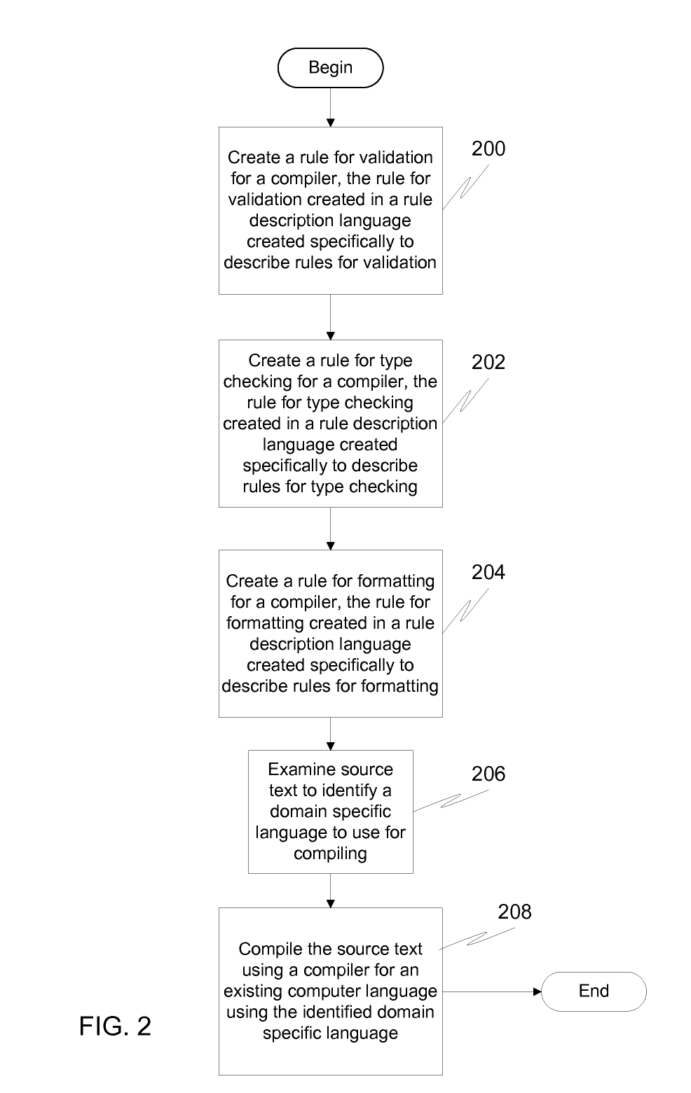

FIG. 2 is a flow diagram illustrating a method for using a domain specific computer language to extend an existing computer language in accordance with an embodiment of the present invention. Steps 200-204 are steps undertaken to create a particular domain specific computer language. These steps may be repeated any number of times to create an unlimited number of domain specific languages. At 200, a rule for validation is created for a compiler, the rule for validation created in a rule description language created specifically to describe rules for validation. At 202, a rule for type checking is created for a compiler, the rule for type checking created in a rule description language created specifically to describe rules for type checking. At 204, a rule for formatting is created for a compiler, the rule for formatting created in a rule description language created specifically to describe rules for formatting. Taken together, the rules for validation, type checking, and formatting, along with other rules for grammar and rules for operational semantics, can comprise a domain specific computer language created by the user. These rules are external from a compiler (i.e., not “baked into” the compiler as in the prior art).

Steps 206-208 are steps undertaken at compile-time. Specifically, at step 206, source text is examined to identify a domain specific language to use for compiling. This may be determined in a number of different ways. For example, the source text can explicitly state which domain specific language should be used (by using, for example, an “import” command). Alternatively, it can be deduced from the source text which language to use (by using, for example, keywords or key phrases). At 208, a compiler for an existing computer language is run on the source text using the identified domain specific language, wherein the compiler contains a rule interpretation engine that runs the rules for validation, type checking, and formatting defined for the identified domain specific language.

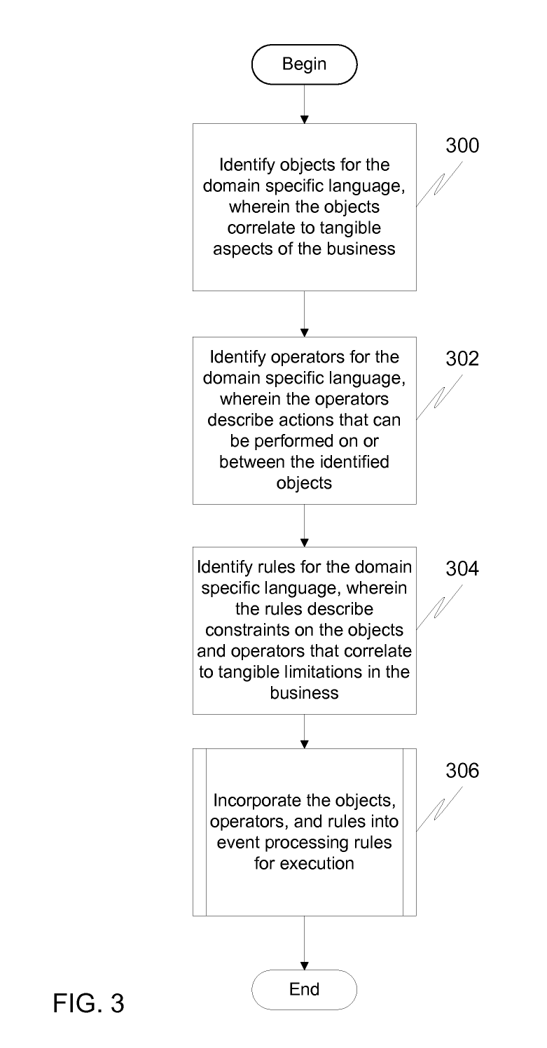

FIG. 3 is a flow diagram illustrating an alternative method in accordance with an embodiment of the present invention. Here, the method is for creating a domain specific language for a business. The method starts with, at 300, identifying objects for the domain specific language, wherein the objects correlate to tangible aspects of the business. At 302, operators for the domain specific language are identified, wherein the operators describe actions that can be performed on or between the identified objects. At 304, rules for the domain specific language are identified, wherein the rules describe constraints on the objects and operators that correlate to tangible limitations in the business. At 306, the objects, operators, and rules are incorporated into rules for execution.

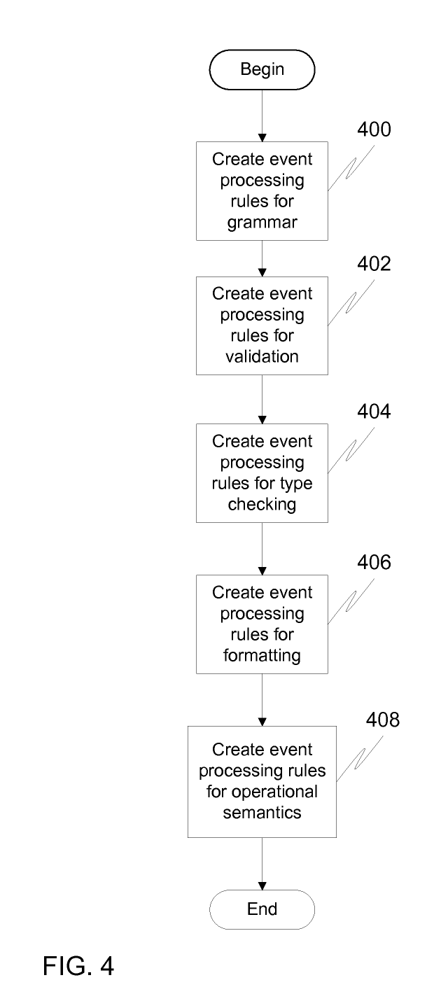

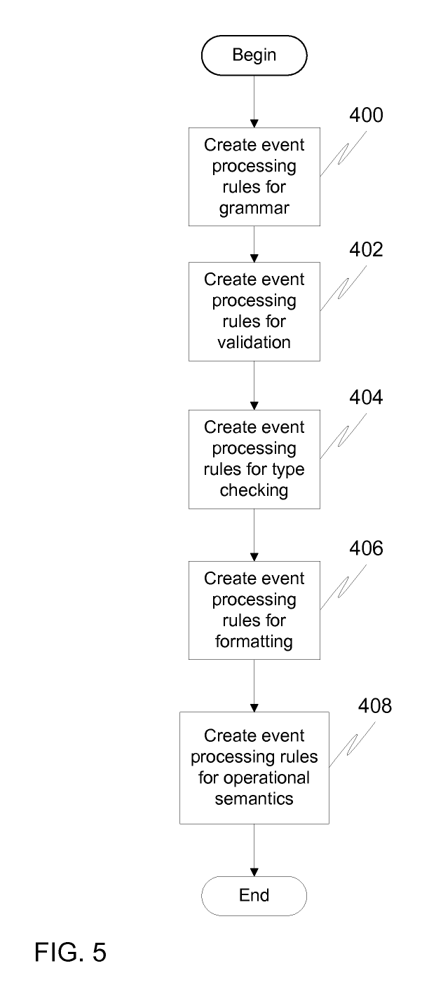

FIG. 4 is a flow diagram illustrating a method for incorporating objects, operators, and rules into rules for execution in a system in accordance with an embodiment of the present invention. This diagram represents step 306 of FIG. 3 in more detail. At 400, rules for grammar are created. At 402, rules for validation are created. At 404, rules for type checking are created. At 406, rules for formatting are created. At 408, for operational semantics are created. The rules for validation may be created using a tool for authoring rules for validation, in a rule description language created for authoring rules for validation. The rules for type checking may be created using a tool for authoring rules for type checking, in a rule description language created for authoring rules for type checking. The rules for formatting may be created using a tool for authoring rules for formatting, in a rule description language created for authoring rules for formatting.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations, or as computer readable code on a computer readable medium for controlling a manufacturing line used to fabricate thermoplastic molded parts. The computer readable medium is defined as any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

1. A method for using a domain specific computer language to extend an existing computer language, comprising:
creating a rule for validation for a compiler, the rule for validation created in a rule description language created specifically to describe rules for validation, the rule defining a part of the domain specific computer language;
examine source text to identify a domain specific language to use for compiling; and
compiling the source text using a compiler for an existing computer language using the identified domain specific language, wherein the compiler contains a rules interpretation engine that runs the rules for validation for the identified domain specific language, wherein the rules for validation are external to the compiler.

2. The method of claim 1, further comprising:
creating a rule for type checking for a compiler, the rule for type checking created in a rule description language created specifically to describe rules for type checking, the rule for type checking defining a part of the domain specific computer language.

3. The method of claim 1, further comprising:
creating a rule for formatting for a compiler, the rule for formatting created in a rule description language created specifically to describe rules for formatting, the rule for formatting defining a part of the domain specific computer language.

4. The method of claim 1, wherein the domain specific computer language contains rules for grammar, rules for validation, rules for type checking, rules for formatting, and rules for operational semantics.

5. A method for creating a domain specific language for a business, the method comprising:
identifying objects for the domain specific language, wherein the objects correlate to tangible aspects of the business;
identifying operators for the domain specific language, wherein the operators describe actions that can be performed on or between the identified objects;
identifying rules for the domain specific language, wherein the rules describe constraints on the objects and operators that correlate to tangible limitations in the business; and
incorporating the objects, operators, and rules into a domain specific language external from a compiler but compatible with a rule interpretation engine inside the compiler.

6. The method of claim 5, wherein the incorporating includes:
creating rules for grammar;
creating rules for validation;
creating rules for type checking;
creating rules for formatting; and
creating rules for operational semantics.

7. The method of claim 6, wherein the creating rules for validation includes using a rule description language created specifically to describe rules for validation.

8. The method of claim 6, wherein the creating rules for type checking includes using a rule description language created specifically to describe rules for type checking.

9. The method of claim 6, wherein the creating rules for formatting includes using a rule description language created specifically to describe rules for formatting.

10. The method of claim 5, wherein the domain specific language extends an existing computer language.

11. The method of claim 10, wherein the rules for the domain specific language identify constraints that are stronger constraints than could be created by a tool for extending the existing computer language that is a part of the existing computer language itself.

12. An apparatus comprising:
a tool for authoring rules for validation, in a rule description language created for authoring rules for validation, of a domain specific language;
a tool for authoring rules for type checking, in a rule description language created for authoring rules for type checking, of the domain specific language; and
a tool for authoring rules for formatting, in a rule description language created for authoring rules for formatting, of the domain specific language.

13. A program storage device readable by a machine and tangibly embodying a program of instructions executable by the machine to perform a method for using a domain specific computer language to extend an existing computer language, the method comprising:
creating a rule for validation for a compiler, the rule for validation created in a rule description language created specifically to describe rules for validation, the rule defining a part of the domain specific computer language;
examine source text to identify a domain specific language to use for compiling; and
compiling the source text using a compiler for an existing computer language using the identified domain specific language, wherein the compiler contains a rules interpretation engine that runs the rules for validation for the identified domain specific language, wherein the rules for validation are external to the compiler.

14. The program storage device of claim 13, wherein the method further comprises:
creating a rule for type checking for a compiler, the rule created in a rule description language created specifically to describe rules for type checking, the rule for type checking defining a part of the domain specific computer language.

15. The program storage device of claim 13, wherein the method further comprises:
creating a rule for formatting for a compiler, the rule created in a rule description language created specifically to describe rules for formatting, the rule for formatting defining a part of the domain specific computer language.

16. The program storage device of claim 13, wherein the domain specific computer language contains rules for grammar, rules for validation, rules for type checking rules for formatting, and rules for operational semantics.

17. The program storage device of claim 13, wherein the domain specific language identifies constraints that are stronger constraints than could be created by a tool for extending the existing computer language that is a part of the existing computer language itself.
